(19) United States
(12) Patent Application Publication
(10) Pub. No.: US 2004/0149655 A1
(43) Pub. Date: Aug. 5, 2004

(54) Methods and systems for purifying fluids and regenerating purification media

(75) Inventors: Michael Petrucco, Tully, NY (US); Scott Caothien, Irvine, CA (US); Jay Jackson, Groton, NY (US); Jan Cornelius, Brooktondale, NY (US); Joseph Swiezbin, Glen Head, NY (US)

Correspondence Address: LEYDIG VOIT & MAYER, LTD, 700 THIRTEENTH ST. NW, SUITE 300, WASHINGTON, DC, 20005-3960, US

(73) Assignee: Pall Corporation, East Hills, NY

(21) Appl. No.: 10/355,265

(22) Filed: Jan. 31, 2003

(51) Int. Cl. B01D 65/02

(52) U.S. Cl. 210/636; 210/650; 95/45

(57) ABSTRACT

A system and method for purifying a fluid and a method for regenerating a permeable purification medium comprise contacting a purification medium with a warm cleaning liquid for a period of time.

### FIELD OF THE INVENTION

The invention relates to methods and systems for purifying fluids and regenerating permeable purification media. For example, methods and systems embodying the invention may be used to remove foulant materials which accumulate on or within purification media, thereby substantially or even completely restoring the permeability of the purification media.

### DISCLOSURE OF THE INVENTION

Permeable purification media, such as porous filter media, may be used to purify many different fluids, including fluids such as gases, liquids, and mixtures of gases, liquids, and/or solids. In use, the fluid is directed to the permeable purification medium. In a dead-end mode of operation, all of the fluid passes as permeate through the purification medium from a feed side of the medium to the permeate side. In a cross-flow mode of operation, a portion of the fluid passes as permeate through the purification medium from the feed side to the permeate side, while the remainder of the fluid, e.g., the retentate, continues along the feed side past the purification medium.

In any mode of operation, foulant materials can accumulate within the purification medium or on one or both sides of the purification medium, decreasing the permeability of the medium and making it harder to force permeate through the purification medium. There are many types of foulant materials. For example, inorganic foulant materials, such as metal hydroxides and carbonates, can precipitate from liquid fluids due to changes in the chemistry of the fluid and can accumulate on or in the purification medium. Particulant foulant materials, such as solids or colloids, suspended in the fluid can be deposited on or within the purification medium. Biological foulant materials, such as bacteria or algae, can establish colonys on or within the purification medium, e.g., as a biofilm, and can generate extracellular polymeric substances which accumulate as a viscous, slimy gel. Organic foulant materials, such as TOCs, suspended in the fluid can also be deposited on or within the permeable purification medium. The invention provides methods and systems for purifying fluids and regenerating purification media which may be fouled with these and other foulant materials.

In accordance with one aspect of the invention, methods for purifying a fluid comprise directing a flow of fluid to a purification medium, including passing permeate through the purification medium. The methods further comprise interrupting the flow of fluid, contacting the purification medium with a warm cleaning liquid for a period of time, removing foulant materials from the purification medium and reestablishing the flow of fluid to the purification medium.

In accordance with another aspect of the invention, methods for regenerating a permeable purification medium comprise contacting the purification medium with a warm cleaning liquid for a period of time and removing foulant materials from the purification medium.

In accordance with another aspect of the invention, systems for purifying a fluid comprise a permeable purification medium having a first side and a second side, the first side of the purification medium communicating with the fluid. The systems further comprise a source of warm cleaning liquid. The source of warm cleaning liquid is coupled to the purification medium to establish contact between the warm cleaning liquid and the purification medium for a period of time.

Systems embodying one or more aspects of the invention may include the purification medium as part of a purification assembly, and the purification assembly may be configured in a number of different ways. For example, the purification assembly may comprise one or more disposable or reusable housings, such as a vessel or a casing, each housing containing one or more purification elements. The housing may have any desired configuration and may include two or more ports. For example, the housing may include an inlet port, a permeate outlet port, a retentate outlet port, a drain, and/or one or more vents. The housing preferably defines one or more flow paths, for example, between the inlet port and the permeate outlet port, and contains each purification element in the fluid flow path.

Each purification element may include the permeable purification medium, and the purification medium preferably has a feed fluid side, e.g. an upstream side, which fluidly communicates with the inlet port of the housing and a permeate side, e.g., a downstream side, which fluidly communicates with the permeate outlet port of the housing. The permeable purification medium may be a porous, permeable or semipermeable medium including a microfiltration, ultrafiltration, or nanofiltration filter medium. The purification medium may be in the form of hollow fibers, hollow tubes, a fibrous mass, a sheet of fibrous material, or a permeable or semipermeable membrane or in any other form and may be fashioned from metal, ceramic, glass or natural or synthetic polymers or from any other material compatible with the fluid to be purified. The purification elements may include additional components such as drainage layers, a core, a cage, and one or more end structures or end caps, and may be fashioned, for example, as hollow fiber modules, tube bundles, pleated filter elements, or non-pleated filter elements, including spiral-wound elements.

In addition to the purification medium, systems embodying the invention also include a source of warm cleaning liquid. The source of warm cleaning liquid may be a separate system or subsystem coupled to the purification assembly in any desired manner or the source may be an integral portion of the purification system. While a variety of liquids may be used as cleaning liquids, including, for example, alcohol, aqueous cleaning liquids, e.g., plain water or a mixture of water and other liquids, are preferred. Thus, the source may include a pipe which delivers water or a tank which contains water. For example, in water purification applications, a portion of the permeate water may be stored as the cleaning liquid, for example, in a tank downstream of the purification assembly.

The source of warm cleaning liquid may also include a heater of any suitable type. The heater may be an electrical heater, a gas or fuel oil heater, or a steam heater, for example. In many preferred embodiments, the heater is a tank-type water heater which both stores and heats the cleaning liquid. The heater may heat the cleaning fluid to any desired temperature depending, for example, on such factors as the nature of the foulant materials and the nature of the purification assembly. For many preferred embodiments, the temperature may be in the range from about 20° C. or less to about 50° C. or more and, more preferably, in the range from about 25° C. to about 45° C. or from about 32° C. to about 40° C.

While the cleaning liquid may have as its sole constituent the liquid, for example, plain, clean water, preferred cleaning liquids are preferably a mixture of a liquid, e.g., water, and one or more additives, such as a cleaning agent and/or a biocide. Consequently, the source of warm cleaning liquid may further include a mechanism for adding or injecting one or more additives into the liquid, which mechanism may further include a mixer for providing a uniform mixture of the liquid and the additive(s). The additives may be combined with the liquid at any point in the liquid stream from the purification medium. The type and amount of additives to be added to the liquid depend on such factors as the nature of the fluid being purified, the nature of the foulant materials and the nature of the purification medium. Cleaning agents, including acids such as HCl, phosphoric, nitric, and citric acid and ammonium bifluoride, bases such as NaOH, and surfactants, and biocides, including Cl₂, ClO₂, and NaOCl, may be added to the liquid in any desirable concentration. For example, a concentration of about 200 to about 20000 or, more preferably, about 500 to about 10000, mg/L of acid may be desirable in some applications. A concentration of about 50 to about 2000 or, more preferably, about 200 to about 1000, mg/L of chlorine in water or a concentration of about 50 to about 2000 or, more preferably, about 100 to about 1000, ppm of NaOCl in water may be desirable in some applications. However, the type and concentration of additives may best be determined empirically for any given system.

In addition to the purification medium and the source of warn cleaning liquid, systems for purifying a fluid may include additional components. Pumps, valves and sensors may be used to move the feed fluid, permeate and cleaning liquid through the system in accordance with the commands of a control system, for example. Further, the methods of regenerating purification media according to the invention may be used alone or in combination with other cleaning methods, including mechanical or hydraulic scrubbing methods, such as air scrubbing, and fluid regeneration methods such as backwash or blowback arrangements. International Publication No. WO 00/13767 illustrates some of these other cleaning methods. Consequently, systems embodying the invention may also include valves, pipes, pumps, scrubbers and other components to effect the additional cleaning methods.

In operation, feed fluid is directed through the inlet port of the purification assembly to the feed side of the permeable purification medium during a purification phase. Any type of feed fluid, including a wide variety of gases, liquids, and mixtures of gases, liquids and solids, may be purified. However, many preferred embodiments of the invention are used for municipal, industrial, and waste water purification where the feed fluid is contaminated water. The feed fluid contacts the permeable purification medium and at least a portion of the feed fluid passes as permeate through the purification medium from the feed side to the permeate side. The permeate then exits the purification assembly through the permeate outlet port, and in cross-flow mode, the remainder of the feed fluid continues along the feed side of the purification medium and exits the purification assembly through the retentate outlet.

As the feed fluid passes through the purification assembly, foulant materials begin to accumulate on or within the purification medium, decreasing the permeability of the medium and the flux rate through the medium and increasing the differential pressure from the feed side to the permeate side of the purification medium. Recurrently or, preferably, periodically, the flow of feed fluid through the purification assembly may be interrupted to initiate a regeneration phase, for example, by closing a valve in the feed line to the inlet port of the purification assembly, and the purification assembly may, or may not, be drained of one or both the feed fluid and the permeate. The warm cleaning liquid may then be directed into contact with the purification medium to begin regenerating the medium by removing some or all of the foulant materials.

Conventionally, purification media were cleaned only after the foulant materials had substantially impaired the performance of the purification media. For example, the media were cleaned only after an extended period of time (e.g., every 30 days or more) and/or once sufficient foulant materials had accumulated on or within the media to substantially decrease the permeability of the media and substantially increase the differential pressure across the media. Methods and systems embodying the invention may also be used to interrupt the flow of feed fluid and regenerate the purification medium only after such an extended time or such substantial impairment of the media. However, this approach is less preferable because it is more difficult to effectively regenerate a substantially fouled purification medium than it is to regenerate a slightly fouled medium.

Methods and systems embodying the invention more preferably interrupt the flow of feed fluid and regenerate the purification medium more frequently and when the medium has less foulant materials. For example, the flow of feed fluid may be interrupted and the purification medium may be regenerated once every two weeks or once a week or, more preferably, once every 5 days or 3 days or, most preferably, daily. Further, the flow of feed fluid may be interrupted and the purification medium may be regenerated even for relatively clean purification elements, for example, new elements or elements which exhibit substantially no decrease in permeability or increase in differential pressure. This new regeneration strategy has many advantages. For example, fewer types of additives and/or lower concentrations of additives may be use to regenerate the purification medium. Further, the cleaning liquid and the purification medium may be in contact for shorter periods of time during each regeneration cycle, resulting in less downtime. In addition, the life of the purification elements may be extended because they stay cleaner longer.

Once the flow of feed fluid is interrupted, the warm, cleaning liquid may be directed into contact and may be maintained in contact with the purification medium in a number of ways. For example, the warm cleaning liquid may be directed into the purification assembly and into contact with the purification medium through the inlet port, the retentate outlet port, and/or separate cleaning liquid port on the feed side of the purification medium. Preferably, the warm cleaning liquid is directed into the purification assembly on the permeate side of the purification medium, e.g., through the permeate outlet port.

Further, the warm cleaning liquid may be maintained in contact with the purification medium only on one side, the feed side or the permeate side, of the purification medium. For example, the permeate side of the purification medium may be closed and the cleaning liquid may be maintained in contact with the feed side only. Cleaning liquids are preferably liquids which will wet the purification medium, allowing the pores of the medium to be filled with the cleaning liquid from either side of the medium. Preferably, the warm cleaning liquid is maintained in contact with both sides of the purification medium.

In addition, the cleaning liquid may be maintained in contact with the purification medium either statically, for example, by soaking the medium in the cleaning liquid, or dynamically, for example, by passing or recirculating the cleaning liquid along or through the medium. For example, the feed fluid may be drained from the purification assembly and the purification assembly may be filled with the warm cleaning liquid, preferably completely filled along both sides of the purification medium, allowing the medium to soak in the cleaning liquid. Alternatively, the flow of feed fluid may be interrupted and the warm cleaning liquid may be passed or recirculated through the purification assembly via any of the ports, with or without first draining the feed fluid. The flow rate or flux rate of the cleaning fluid may vary depending on many factors such as the nature of the purification assembly and the nature of the foulant materials. In some embodiments, a flux rate in the range from about 0.004 to about 0.030 or, more preferably, about 0.008 to about 0.015, gpm/ft² may be desirable. However, the flow rate or the flux rate for the cleaning fluid may best be determined empirically for a given application.

The period of time during which the warm cleaning liquid is maintained in contact with the purification varies depending on many factors including the available downtime and the desired degree of cleanliness as well as the nature of the foulant materials and the purification assembly. For many preferred embodiments, the contact time, e.g., the soak time and/or the circulation time, may be in the range from about 5 minutes or less to about 60 minutes or more. However, the contact time may best be determined empirically for a given system and application.

Throughout the contact time, the warm cleaning liquid is preferably removing foulant materials from the purification medium, for example, by dissolving, loosening and/or lifting the foulant materials from the medium. However, additional cleaning methods may be applied to the purification medium, either before, while or after the warm cleaning liquid contacts the purification medium. For example, the purification medium may be gas scrubbed and backwashed after the warm cleaning liquid has contacted the purification medium.

After the period of time during which the cleaning liquid contacts the purification medium, the cleaning liquid is preferably removed from the purification assembly prior to resuming the purification phase and reestablishing purification of the feed fluid. For example, the cleaning liquid may, or may not, be drained from the purification assembly, and a flush liquid may be directed through the purification assembly, including the purification medium, to remove the cleaning liquid and the removed foulant materials. The flush liquid may be directed into the purification assembly through any suitable port. For example, a flush liquid, such as stored permeate, may be directed in a reverse flow mode from the permeate outlet port through the purification medium to either or both of the inlet port and the retentate outlet port. Alternatively, a flush liquid such as the feed liquid may be directed in a forward flow mode from the inlet port through the purification medium to the permeate outlet port, where the flush liquid may then be redirected to a feed tank or discharged to a drain. The duration and flow rate of the flush are preferably sufficient to remove all or a substantial portion of the cleaning liquid and foulant materials, and both the duration and flow rate may best be determined empirically for a given system and application.

Once the purification assembly has been flushed, the flush liquid may, or may not be, drained from the purification assembly and purification of the feed fluid may be resumed by reestablishing feed fluid flow into the inlet port of the purification assembly. Embodiments of the invention may continue to be cycled between the purification phase and the regeneration phase for an extended period of operation.

### BRIEF DESCRIPTION OF THE DRAWING

FIG. 1 is a block diagram representing an example of a purification system.

### DESCRIPTION OF THE EMBODIMENTS

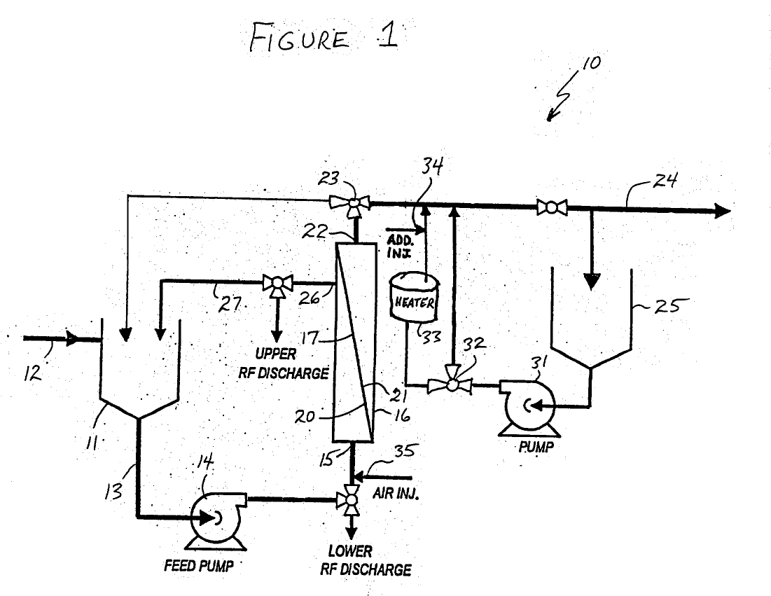

An example of a system 10 for purifying a fluid such as contaminated water is shown in FIG. 1. Contaminated water may be fed to a feed tank 11 via a feed line 12. From the feed tank 11, the contaminated water may be fed during the purification phase via a supply line 13 and a feed pump 14 to the inlet port 15 of a purification assembly 16, such as a hollow fiber module. The purification assembly 16 includes a purification medium 17, for example, hollow fibers, and the purification medium 17 has a feed side 20 and a permeate side 21, for example, the outside and the inside of the hollow fibers or vice versa. The contaminated water contacts the feed side 20 of the purification medium 17 and a portion of the contaminated water may pass as permeate, e.g., purified water, through the purification medium 17 to the permeate side 21. The purified water passes from the purification assembly 16 via a permeate outlet 22 and is discharged via a valve 23 and a permeate discharge line 24. A portion of the purified water may be collected in a permeate tank 25. The remainder of the contaminated water passes as retentate from the purification assembly 16 via a retentate outlet 26 and may be returned to the feed tank 11 via a return line 27.

The forward flow of contaminated water may be interrupted and a regeneration phase may be initiated, preferably daily. For example, fluid may be drained from the purification assembly 16 via the lower inlet port 15. Purified water may then be fed from the permeate tank 25 via a pump 31 and a valve 32 to a water heater 33, where the purified water may be heated in the range from about 25° C. to about 45° C. Additives may be added to the heated water at one or more injection points 34 to generate the warm cleaning liquid. For example, chlorine or NaOCl may be added to the purified water to form the cleaning liquid. The source of the cleaning liquid may thus comprise the permeate tank 25, the water heater 33 and the injection point 34.

The warm cleaning liquid may then be directed in a reverse flow through the permeate outlet 22, filling and soaking the entire purification assembly 16 on both sides 20, 21 of the purification medium 17 with cleaning liquid, for example, at about 38° C. and with about 500 ppm NaOCl or with about 500 ppm chlorine. The cleaning liquid may remain in contact with the purification medium 17 for a soak period of about 30 minutes, removing foulant materials from the purification medium 17. The purification medium 17 may also be scrubbed by an air scrub from the air injection port 35 and subjected to a reverse flow backwash from the purified water in the permeate tank 25, for example, after the soak period. The air scrub and the backwash may be simultaneous or sequential. Alternatively, only the air scrub or only the backwash or neither the air scrub nor the backwash may be combined with regeneration by the warm cleaning liquid.

The cleaning liquid may be flushed from the purification assembly 16 by a reverse flow of purified water, for example, from the permeate tank 25 or by a forward flow of feed water from the feed tank 11 to drain. After the purification assembly 16 is flushed, the purification phase may be initiated by reestablishing a flow of contaminated water into the purification assembly 16.

In another embodiment of the invention, the purification phase may be initiated and continued as previously explained. Again, however, the purification phase may be terminated by interrupting the flow of contaminated water to the purification assembly 16 and the regeneration phase may be initiated, preferably, daily.

In the regeneration phase, both the feed tank 11 and the purification assembly 16 may be drained. Heated cleaning liquid may then be generated as previously explained and supplied to the purification assembly 16 and/or to the feed tank 11, either directly or through the retentate outlet 26 of the purification assembly 16.

The feed pump 14 may then recirculate the cleaning liquid from the feed tank 11 through the inlet port 15 into the purification assembly 16. The cleaning liquid may then contact purification medium 17, a portion of the cleaning liquid passing from the feed side 20 through the purification medium 17 to the permeate side 21 and hence out the permeate outlet 22. The remainder of the cleaning liquid passes along the purification medium 17 on the feed side 20 and hence out the retentate outlet 26. The cleaning liquid from both outlets 22, 26 may be returned to the feed tank 11. The cleaning liquid may thus be recirculated for a period of time, e.g., about 5 to about 60 minutes, through the purification medium 17, removing foulant materials.

The purification assembly 16 may also be subjected to a reverse flow backwash from the permeate tank 25 and an air scrub from the air injection port 35, for example, after the recirculation period of the cleaning liquid and after the feed tank 11 and the purification assembly 16 have been drained of the cleaning liquid. The purification assembly 16 may then be flushed and the purification phase can be reestablished, both as previously explained.

Various aspects of the invention have been described with respect to many embodiments. However, the invention is not limited to these embodiments. For example, one or more of the features of any of these embodiments may be combined with one or more of the features of the other embodiments without departing from the scope of the invention. Further, one or more of the features of any of these embodiments may be modified or omitted without departing from the scope of the invention. Accordingly, the various aspects of the invention include all modifications encompassed within the spirit and scope of the invention as defined by the following claims.

1. A method for regenerating a permeable purification medium comprising:
contacting the purification medium with a warm cleaning liquid for a period of time and removing foulant materials from the purification medium.

2. A method for purifying a fluid comprising:
directing a flow of fluid to a purification medium including passing permeate through the purification medium;
interrupting the flow of fluid;
contacting the purification medium with a warm cleaning liquid for a period of time;
removing foulant material from the purification medium; and
reestablishing the flow of fluid to the purification medium.

3. A system for purifying a fluid comprising:
a permeable purification medium having a first side and a second side, the first side communicating with the fluid and
a source of warm cleaning liquid coupled to the purification medium to establish contact between the warm cleaning liquid and the purification medium for a period of time.
